(19) United States
(12) Patent Application Publication
(10) Pub. No.: US 2020/0285678 A1
(43) Pub. Date: Sep. 10, 2020

(54) METHOD AND SYSTEM FOR MACHINE-ASSISTED CROSS-PLATFORM DESIGN SYNCHRONISATION

(71) Applicant: KISS DIGITAL MEDIA PTY LTD, Monbulk, Victoria (AU)

(72) Inventors: Ivo Ruben Willem JAGER, Monbulk (AU); Renee May FULTON, Monbulk (AU)

(21) Appl. No.: 16/092,295

(22) PCT Filed: Apr. 11, 2017
(86) PCT No.: PCT/AU2017/000084

§ 371 Date: Oct. 9, 2018

(30) Foreign Application Priority Data
Apr. 11, 2016 (AU) 2016901336

(51) Int. Cl. G06F 16/958; G06F 40/40; G06F 40/30; G06F 40/279; G06F 40/103

(52) U.S. Cl. CPC G06F 16/958; G06F 40/40; G06F 40/103; G06F 40/279; G06F 40/30

(57) ABSTRACT

The present invention relates to the creation and design of digital content. In one form a method is provided for producing a user-preferred digital media content design by automatically configuring one or a combination of hints for representing content which is non-specific to a terminating platform, the method including the steps of: mapping components of at least one imperative derived from user input to respective hint classes, matching all hints from a set of known hints with the hint classes that have been mapped with the components of the at least one imperative derived from user input, and combining the matched hints with an existing collection of hints.

### RELATED APPLICATIONS

This application claims priority to Australian Provisional Patent Application No. 2016901336 in the name of Kiss Digital Media Pty. Ltd, which was filed on 11 Apr. 2016, entitled “Method and System for Machine-Assisted Cross-Platform Design Synchronisation” and the specification thereof is incorporated herein by reference in its entirety and for all purposes.

### FIELD OF INVENTION

The present invention generally relates to handling of digital content. In particular, the present invention relates to the creation and design of digital content. It will be convenient to hereinafter describe the invention in relation to the use of hints, as defined herein, accompanying components of digital content in order to invoke a design brief for composing cross-platform digital media content for publication, however it should be appreciated that the present invention is not limited to that use, only.

### BACKGROUND ART

Throughout this specification the use of the word “inventor” in singular form may be taken as reference to one (singular) inventor or more than one (plural) inventor of the present invention.

It is to be appreciated that any discussion of documents, devices, acts or knowledge in this specification is included to explain the context of the present invention. Further, the discussion throughout this specification comes about due to the realisation of the inventor and/or the identification of certain related art problems by the inventor. Moreover, any discussion of material such as documents, devices, acts or knowledge in this specification is included to explain the context of the invention in terms of the inventor's knowledge and experience and, accordingly, any such discussion should not be taken as an admission that any of the material forms part of the prior art base or the common general knowledge in the relevant art in Australia, or elsewhere, on or before the priority date of the disclosure and claims herein.

Since the advent of multiple forms of mass-media such as newspapers, radio and television, it has been the case that brands, businesses, governments and even individuals, have been forced to broadcast their message, regardless of its contents, in different forms suitable to these different media, in order to reach the largest audience possible.

More recently, the amount and variety of media that these entities can choose to broadcast their message upon has expanded significantly with the advent of new forms of digital communication media such as websites, social media, apps, e-mail and other interactive media. These developments have arguably had a fragmenting effect on the media landscape, while the sometimes ephemeral nature of the popularity of some of these platforms (for example social media platforms, or smartphone operating systems) has made targeted investment in these platforms a risky and costly proposition in terms of return on investment (ROI).

Reference is made to the present applicant's co-pending international patent application published as WO 2014/165933 (Kiss Digital Media Pty Ltd) and the disclosure of that prior published application is incorporated herein by reference in its entirety. The systems and methods disclosed by WO 2014/165933 alleviate the above noted problems by providing cross-platform content storage, distribution, creation and playback of digital media content. While technical solutions such as those taught by WO 2014/165933 greatly reduce the complexity and cost of the storage, distribution, creation and playback of cross-platform content, it is considered that they do not, a priori, address the complexity and cost of creating tailor-made, custom designed experiences for producers of digital media content that would rely on such systems for storage, distribution, creation and playback of the associated content.

It is therefore considered that there is a need for allowing a user to express a preferred look and feel that is carried through across multiple platforms, services and media at once, while still conforming to their best practices and capabilities.

Where prior art systems that deal with content dissemination for a single platform, service or medium (such as Wix™, Weebly™, Squarespace™, MailChimp™ and Appy Pie™) sometimes do offer styling capabilities, these styling capabilities take the shape of complex tools and interfaces for do-it-yourself design, such as drag & drop interfaces and template browsers. These functions are provided in lieu of mimicking the way a user would delegate the design to a professional real-life human designer schooled in the art. Even more recent, “artificially intelligent” single-platform products, such as The Grid™ offer mere abstractions of these human interactions, only offering broad stroke control over the final look & feel. Moreover, for The Grid™, feedback on the look & feel can only be given after several minutes of computation by an on-line server.

It is also considered that there is a need for providing cross-platform design services over multiple platforms and media.

U.S. Pat. No. 5,860,073 (Ferrel et al) discloses the use of style sheets for application to individual display regions of a page (document). Specifically, Ferrel describes a feature where styling is performed in pre-allocated regions of a display that may not contain any text yet; as text is added later, this text is styled according to the pre-determined style sheet for this display region. Ferrel et al is an example of simple, rigid, must-follow directions that pertain to styling for specific media and uses, specifically mentioning regions of pages, displays and documents. As such Ferrel et al is considered an example of a conventional naive approach to styling content.

US patent application publication No. 2004/0205588 (Purvis et al) addresses the drawback of pre-determining style sheets in that the styling cannot easily be dynamic, changing with different output devices, or with different document content. Thus, if different styles are required for different sets of content, or a different style for each output device, a style sheet is required for each scenario, which is problematic in terms of anticipating all potential scenarios, as well as a difficult maintenance problem. The solution of Purvis et al is to provide a means to automatically generate a style sheet based on the input content and the output device characteristics by way of the steps of first determining a set of layout constraints such as design criteria (‘soft’ constraints), the requirements of a particular output device, or alternatively, the constraints could be explicitly specified or expressed as properties of a good layout design. Next, according to Purvis et al, the method has the step of representing the style properties of the document as problem variables. These variables could advantageously include font, text line, or colour properties in addition to positioning properties including graphical style. Then, solving the constraint problem and outputting the generated style properties in the form of a style sheet wherein the style sheet is a Cascaded Style Sheet (CSS) or an Extensible Style Language (XSL) specification. Purvis et al is restricted to the CSS or XSL formats and accordingly is dependent on the target platform. Moreover, Purvis et al fails to specify a means for determining the required constraints and criteria for the output content.

US patent application publication No. 2017/0032554 (O'Donovan et al) highlights the problems that arise for many content providers who are not trained or experienced in creating professional and eye-catching digital media. For example, a content provider may wish to design a digital image that has the same “look and feel” as an existing image, but does not have the design experience to do so. This process, however, is frustrating to the untrained and wastes time. O'Donovan also highlights that software packages for editing digital media are generally bulky and require a substantial amount of processing power and memory from the computing device on which the software is running. Thus, in order to successfully edit digital images, a user generally utilizes a larger computing device, such as a laptop or desktop computer. Accordingly, conventional systems provide users little recourse when faced with a need or desire to create or edit digital images “on-the-go” utilizing a handheld device (e.g., a smart phone, tablet, smart wearable) using only an associated touch screen. O'Donovan addresses these problems with a system that filters and presents template digital designs to a user that have been scored based on a compatibility between each template digital design and the user's input digital design. In response to the user selecting one of the presented template digital designs, the system of O'Donovan alters the user's input digital design to match the look-and-feel of the selected template digital design. However, O'Donovan not only requires pre-prepared templates but it also proposes to match an already existing design to this set of prepared templates and lets the user select the closest template, upon which the existing design is modified using the template as a guide. It is considered that this is a clumsy solution in that it is trying to derive styling cues from a piece of existing styled content.

The preceding discussion of the background art is intended to facilitate an understanding of the present invention only. The discussion is not an acknowledgement or admission that any of the material referred to is or was part of the common general knowledge as at the priority date of the application.

### SUMMARY OF INVENTION

It is an object of the embodiments described herein to overcome or alleviate at least one of the above noted drawbacks of prior art systems or to at least provide a useful alternative to prior or related art systems.

In a first aspect of embodiments described herein there is provided a method of producing a user-preferred digital media content design by automatically configuring one or a combination of hints for representing content which is non-specific to a terminating platform, the method comprising the steps of: mapping components of at least one imperative derived from user input to respective hint classes; matching all hints from a set of known hints with the hint classes that have been mapped with the components of the at least one imperative derived from user input. In preferred embodiments, the steps of mapping and matching are repeated, and furthermore the method may further include the step of combining the matched hints with an existing collection of hints. In these preferred aspects, the process becomes an iterative process.

Preferably, the hints comprise a composite of parent and/or child hints. Furthermore, the composite of parent and/or child hints is derived from an archetypal graph.

In preferred embodiments, the at least one imperative is derived from user input by use of natural language processing. Preferably, the components of derived imperatives comprise a range of progressively conceptually abstract user input.

The step of mapping further may include mapping a vector associated with a hint as a measure of specificity and in preferred embodiments, the method further comprises the step of searching for hints based on predetermined specificity criteria.

In preferred forms of the method, the step of combining further includes effecting changes to one or more hints within the existing collection of hints or the combined hints. The effected changes may include turning a hint on or off.

In preferred embodiments, the method further comprises the step of solving the archetypal graph to determine a path from first source set of hints to a second target set of hints.

The step of solving may further include determining one or a combination of points on the path between the first source set of hints and the second target set of hints.

In a preferred embodiment, the solving step may further include the step of associating a visual impact score with at least one hint by application of a weighting factor.

Preferably, the method further includes the step of calculating the distance between two collections of hints.

In another aspect of embodiments described herein there is provided apparatus adapted to produce a user-preferred digital media content design by automatically configuring one or a combination of hints for representing content which is non-specific to a terminating platform, said apparatus comprising: processor means adapted to operate in accordance with a predetermined instruction set, said apparatus, in conjunction with said instruction set, being adapted to perform the method as stated above and herein described.

In yet a further aspect of embodiments described herein there is provided an article representing content, characterised by being the product of the method as stated above and herein described.

In preferred embodiments, the article comprises one or a combination of:

a printable document;

a visual display;

an audio-visual display;

an audio playback file;

a multi-media file;

a multi-media display.

In yet a further aspect of embodiments, the present invention provides a computer program product comprising: a computer usable medium having computer readable program code and computer readable system code embodied on said medium for producing a user-preferred digital media content design by automatically configuring one or a combination of hints for representing content which is non-specific to a terminating platform within a data processing system, said computer program product comprising: computer readable code within said computer usable medium for performing the steps of the method as stated above and herein described.

In still another aspect of embodiments, the present invention provides a terminating platform, service or media residing in a digital media system adapted to interpret hints and produce a user-preferred digital media content design according to a method as stated above and herein described.

The embodiments described herein for the present invention proposes a solution that allows both broad-stroke control, in addition to detailed control, allowing a system to mimic the interaction between user and human designer through, for example, natural language processing, in addition to broad-stroke, and more abstract gestures.

The embodiments described herein for the present invention further solves the problem of providing such cross-platform design services over multiple platforms and media; even when regarding single platform content delivery products (such as Wix™ Weebly™, Squarespace™), the design tools associated with such content delivery platforms tend to work only one particular platform as well. A drag & drop interface, for instance, presumes that the rendering hardware provides a means to select and hold down a graphical object while “dragging” it across a screen. In contrast, the present invention still works in the absence of a graphical user interface—for example when only a text interface or audio channel is available.

Finally, the efficiency of the embodiments described herein for the present invention and its constituent algorithms alleviates the need for lengthy on-line computation times, as they are fast enough to be performed on even moderately powerful consumer-grade computing devices, yielding a new look & feel virtually in real-time.

Other aspects and preferred forms are disclosed in the specification and/or defined in the appended claims, forming a part of the description of the invention.

In essence, embodiments of the present invention stem from the realization that the use of hint classes to map user input and all hints being matched to the mapped input mean that, a user defined content design can be expressed as a sum of graphed hints as nodes of a graph and thus address various deficiencies of the prior art such as, for example, insufficient abstracting of styling cues for the purpose of cross-platform or cross-medium use and graceful degradation of styling directives, the lack of a data structure to aid agent-like (ie Artificially Intelligent) behaviour and interfaces, including, but not limited to, natural language interfaces and semantic processing thereof.

Advantages provided by embodiments of the present invention comprise the following:
Embodiments of the present invention propose to reduce the cost and complexity of the creation of tailor-made and custom designed experiences;
Embodiments of the present invention allow for simultaneous directions for the “styling” of the same text in an audio channel, in addition to visually oriented platforms/media;
Embodiments of the present invention provide a system that can autonomously establish and resolve very complex, interdependent, sometimes conflicting or ambiguous, styling preferences and directions;
Embodiments of the present invention provide a method for constraint satisfaction/optimisation, elegantly resolving conflicting styling directions, even being able to communicate in natural language the rationale behind the way it solved the conflicting directions;
Embodiments of the present invention first establish the desired design cues, upon which those styling cues are applied to a set of content still devoid of styling;
Embodiments of the present invention not only do away with templates (the amount of possible combinations allowed by a moderately large hint graph are virtually innumerable), but make it wholly unnecessary to display anything visually in the first place as part of an interface. Further, natural language can be used to steer the design into the desired direction and that a preferred design can be reflected in more than just a visual way.

Further scope of applicability of embodiments of the present invention will become apparent from the detailed description given hereinafter. However, it should be understood that the detailed description and specific examples, while indicating preferred embodiments of the invention, are given by way of illustration only, since various changes and modifications within the spirit and scope of the disclosure herein will become apparent to those skilled in the art from this detailed description.

### BRIEF DESCRIPTION OF THE DRAWINGS

Further disclosure, objects, advantages and aspects of preferred and other embodiments of the present invention may be better understood by those skilled in the relevant art by reference to the following description of embodiments taken in conjunction with the accompanying drawings, which are given by way of illustration only, and thus are not limitative of the disclosure herein, and in which:

FIG. 1 is a flow chart for the recursive processing of representation hints in accordance with an embodiment of the present invention;

FIG. 2 is an archetype graph depicting directional dependencies of nodes representing “text box styling” attributes for use with hints in accordance with an embodiment of the present invention;

FIG. 3 is 2-dimensional matrix displaying closeness of fit of archetypes to a current design in accordance with a preferred embodiment of the present invention;

FIG. 4 is a flow chart of an iterative algorithm for finding a path from a first (source) set of hints to a second (target) set of hints in accordance with embodiments of the present invention;

FIG. 5a illustrates the association of hints with different styling instructions for a target platform in accordance with an embodiment of the present invention;

FIG. 5b illustrates the association of the hints of FIG. 5a with different styling instructions for another target platform in accordance with an embodiment of the present invention;

FIG. 6a is an exemplary representation of a single hint and a description of associated data in accordance with an embodiment of the present invention;

FIG. 6b is an exemplary representation of a single hint and examples of associated data in accordance with an embodiment of the present invention;

FIG. 7a is a system flow chart exemplifying the use of hint class mapping and vector direction mapping in accordance with a preferred embodiment of the present invention;

FIG. 7b is a system flow chart exemplifying the further use of hint class mapping and vector direction mapping in accordance with a preferred embodiment of the present invention;

FIG. 8a is a system flow chart illustrating an example of how user input is mapped to hint classes and then hints in accordance with an embodiment of the present invention;

FIG. 8b is a system flow chart illustrating another example of how user input is mapped to hint classes and then hints in accordance with an embodiment of the present invention;

FIG. 9a is an archetype graph depicting directional dependencies of nodes representing attributes for use with hints in accordance with an embodiment of the present invention;

FIG. 9b is an archetype graph depicting directional dependencies of nodes which illustrate a selection of nodes representing hints that are set for a feminine archetype in accordance with an embodiment of the present invention;

FIG. 9c is an archetype graph depicting directional dependencies of nodes which illustrate a selection of nodes representing hints that are set for a masculine archetype in accordance with an embodiment of the present invention;

FIG. 9d is an archetype graph depicting directional dependencies of nodes which illustrate a selection of nodes representing hints that are set for a valid half-way solution between the feminine archetype of FIG. 9b and the masculine archetype of FIG. 9c in accordance with an embodiment of the present invention;

FIG. 9e is an archetype graph depicting directional dependencies of nodes which illustrate a selection of nodes representing hints that are set for another valid half-way solution between the feminine archetype of FIG. 9b and the masculine archetype of FIG. 9c in accordance with an embodiment of the present invention.

### DETAILED DESCRIPTION

WO 2014/165933 discusses the use of “hints” that accompany a piece of content. For the purposes of this description, it is to be understood that “hints” are instructional information that provide the terminating rendering platform, service or medium, clues much like “serving suggestions” on how to best represent the content it is given. For example, a hint may indicate to a terminating platform, service or medium that preferably, text is to be rendered in a particular colour or in a particular font.

As would be appreciated by the reader, hints may in certain cases be ignored by a terminating platform, service or medium. For example, this may be the case if a hint is inappropriate, or no associated means of interpreting the hint exists, for example, missing code, or if the hint's purpose is simply not applicable, for example, a hint that specifies “yellow text” when the rendering platform is only capable of monochrome rendering.

Preferred embodiments of the present invention as described, provide a method for the automated configuration of complex hint combinations, in such a way that these hint configurations express a design brief that needs to be expressed only once, may be expressed in a more human friendly format, yet achieves the desired design parameters on all platforms, services and media at once provided the terminating platforms, services and media have the means to interpret the hints. Means to interpret the hints are described in WO 2014/165933.

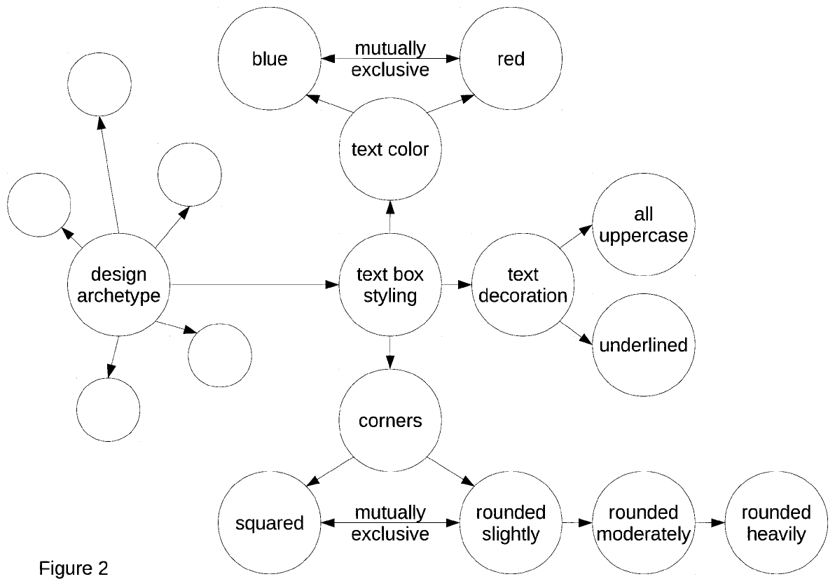

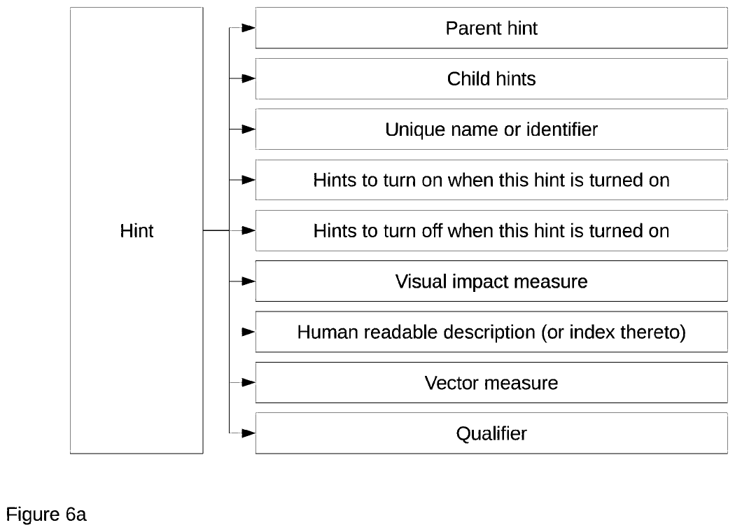

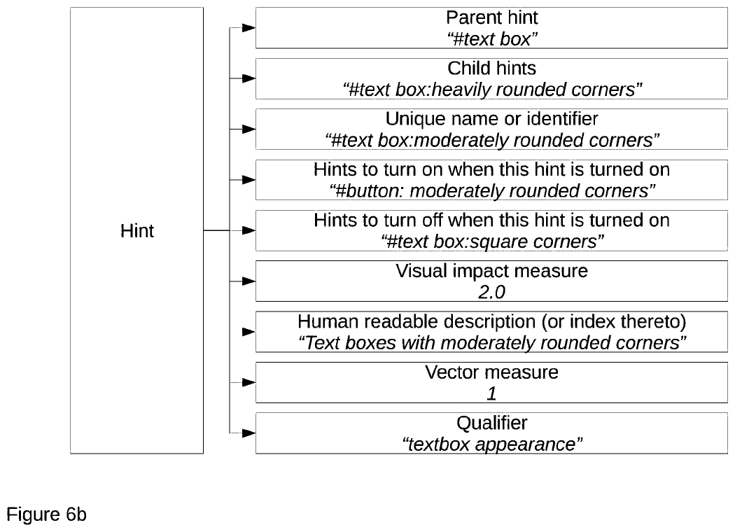

In accordance with a preferred embodiment, the present invention defines relationships between hints by means of a graph, where connected child nodes (child hints) preferably express ever more escalating levels of specificity and/or direction set out by the parent node (parent hint). FIG. 2 is a depiction of an example sub-section of a graph that shows nodes that govern various aspects of “text box styling”, including node interdependencies. A single arrow denotes a parent to child relationship, whereas a double arrow denotes mutual exclusivity. For example, with reference to FIG. 2, a parent node “text color” could have one or more “specific” child nodes such as “blue” and “red”. An example of “specificity” is the relationship of “text box styling” and “corners”, whereby “corners” expresses a more specific sub-attribute of “text box styling”. An example of “direction” in FIG. 2 is the relationship of “rounded slightly”, which has a child “rounded moderately”, which in turn has a child “rounded heavily”. These parent-child relationships are encoded for each node/hint as can been seen by way of example in the data structures depicted in FIG. 6a and FIG. 6b, respectively, therefore making up a graph structure. In this respect, FIG. 6a is a possible representation of a single hint and its associated data. FIG. 6b is also an example of a single hint and its associated data.

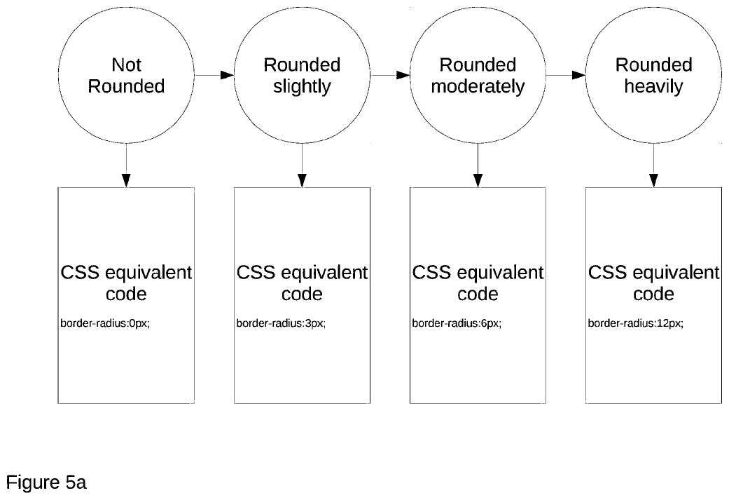

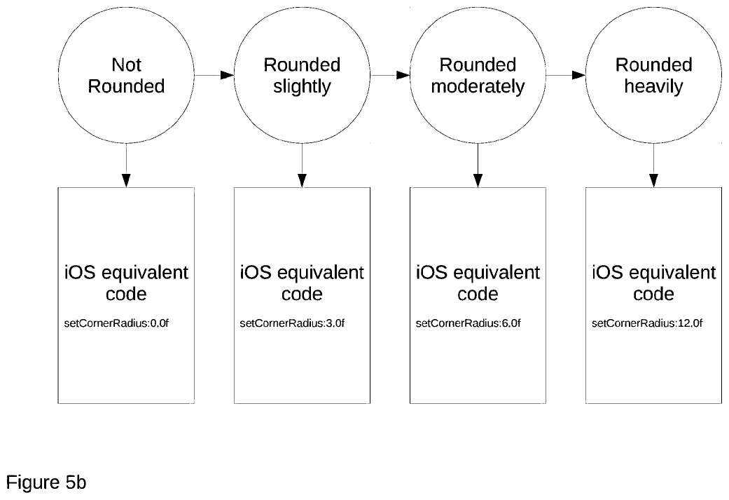

It will be recognised by a person skilled in the art that traversing the graph depending on a user's preferences, and executing any code or styling directives associated with its nodes' unique identifiers, will alter the design that a platform, service or medium executing said code would be showing (see FIG. 5a and FIG. 5b). As the graph branches, different aspects of the design are encoded and can therefore be achieved by visiting these nodes, choosing the relevant path and the associated nodes according to user preferences, and ultimately executing the associated code for each node. FIG. 5a is a representation of how hints are associated with different styling instructions, in this case using the Cascading Style Sheets (CSS) web technology. FIG. 5b, on the other hand, is a representation of how hints are associated with different styling instructions, in this case using Apple iOS UIView instructions.

It will further be recognised by a person skilled in the art that a design can thus be expressed as the sum of nodes that have been visited as the graph is traversed along the preferred path.

Given that a node (with a hint represented therewith)'s descendants preferably express ever more escalating levels of specificity and/or direction, it is to be noted that the code or styling preferences associated with child hints always supersede/override (but not necessarily undo) a parent hint's associated code. For example, in the hint sequence of FIG. 5a and FIG. 5b, the platform-specific styling instructions under “Rounded moderately” would supersede that of “Rounded slightly”. However, if ancestor “Not Rounded” made additional style changes that are not overridden by its children, then those style changes would still be, in effect, on top of what its children specify. This means that the terminating platform's hint interpreter does not require awareness of the graph or the full hint's data structures, however it does require awareness of which styling directions are more specific, as the more specific instructions need to be executed after the less specific instructions due to the possibility of overriding behaviour of the more specific hints.

Encoding escalating specificity, while at the same time being able to ignore hints, makes it possible for different platforms to carry out styling instructions to the best of their abilities in terms of specificity, while other platforms may be able to meet the specificity all the way. For example, a hint specifying the use of feminine font “Lora” (for example, defined by a specific parent-child relationship “typography>feminine>lora”) may be interpreted by one, visually oriented, renderer as a direction to use this more curly typeface by specifically checking for “typography>feminine>lora”. Similarly, in an audio channel a text-to-speech renderer would use the same “typography>feminine>lora” direction to use a female voice (checking for the less specific parent-child relationship “typography>feminine”, as it has no need for the specificity of further children such as “lora”). Yet another platform might completely ignore the hint if it is not able to synthesise a meaningful change in response to that hint (for example due to missing functionality or capability).

Each hint optionally encodes a collection of other hints that should be turned on (e.g. added/set) or off (e.g. removed/unset) upon turning this hint on. This, for example, allows conflicting hints to be turned off in order to, for example, establish mutual exclusivity. For example, with reference to FIG. 2, if we have two hint paths from “text color” to “blue” and from “text color” to “red”, then it would not make sense to have both “blue” and “red” active at any given time as they provide conflicting instructions to a renderer capable of interpreting these hints. Accordingly, it would be appreciated that a piece of text cannot simultaneously be blue and red. Therefore, along with these two hints, an instruction should be encoded to, before setting this hint, turn off the other. This way it can be guaranteed that only one text colour is ever set at any given time. It is to be noted that this feature implicitly introduces sequence of hint expression as an important factor when specifying the collection (for example in the form of an array) of preferred hints (making up a preferred “design” that is to be interpreted by the terminating platform); when solving or interpreting a hint collection (making up a preferred “design”). For example, given the previous example of the two conflicting hints “textColor>red” and “textColor>blue”, then encountering “textColor>red” after previously encountering “textColor>blue” will cancel out the latter.

It shall further be noted that, using the aforementioned mechanism, hints may be turned on or off by other hints which may reside in very different areas of the graph. In this respect, they do not necessarily have an ancestor-descendant relationship. By way of example a hint that governs logo placement may instruct a certain hint combination that governs background color to be neutralised in order for the logo to blend in correctly, which effectively is encoding awareness of clashing design elements. The hint data structure in FIG. 6b, for example, specifies that hint with unique identifier “#button: moderately show rounded corners” is to be turned on and therefore its design code executed as a direct result of turning on “#text box: moderately rounded corners”. This ensures that whenever rounded corners are selected for the design, the buttons shall also adopt rounded corners, so as to keep the design consistent. It is to be noted that if “#button: moderately show rounded corners” itself would have hints associated with it that need to be turned on or off, then as a result of turning this hint on, those hints too will be processed, and so on and so forth. As with other graph structures, it is to be noted that either care must be taken not to encode infinite loops this way (for example caused by hints mutually turning each other on ad infinitum), or that infinite loops are detected and stopped by some other means in a solver (for example by checking if a particular node/hint has been processed before and not process it if that is indeed the case). Similarly, care must also be taken not to create “orphan” hints (unless they are root nodes). When “turning on” a hint, its ancestors, if any, must first also be turned on.

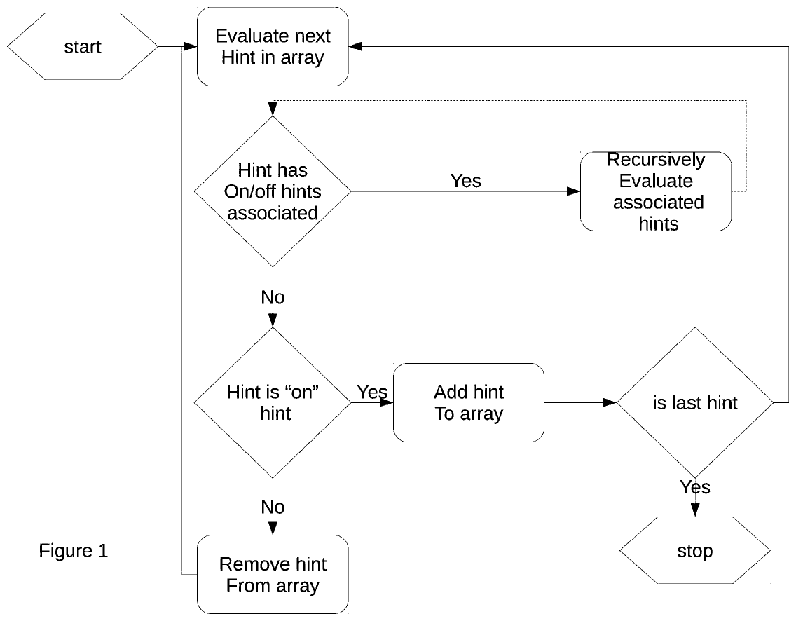

It would be understood by the person skilled in the art that the aforementioned mechanism allows for a single hint to trigger a cascading effect of ever more hints turning on. This allows for the specification of hints that may not necessarily have code associated with them (remembering that any platform-specific code or styling directive association is optional), but function more as a macro or “collection” of hints (analogous to a gene in biology that turns traits on or off) whose inclusion can set in motion a cascade of design expressions. Taking the latter to the extreme, offering a solver, for example the solver depicted by the flow chart in FIG. 1, a single “macro” hint, for example the “design archetype” node in FIG. 2, can express a complete design, as long as its constituent hints (which may be sub-macros themselves) are encoded first as its children. It is to be noted that FIG. 1 is a flow chart describing recursive resolving of one or more hints into its full member hints representation.

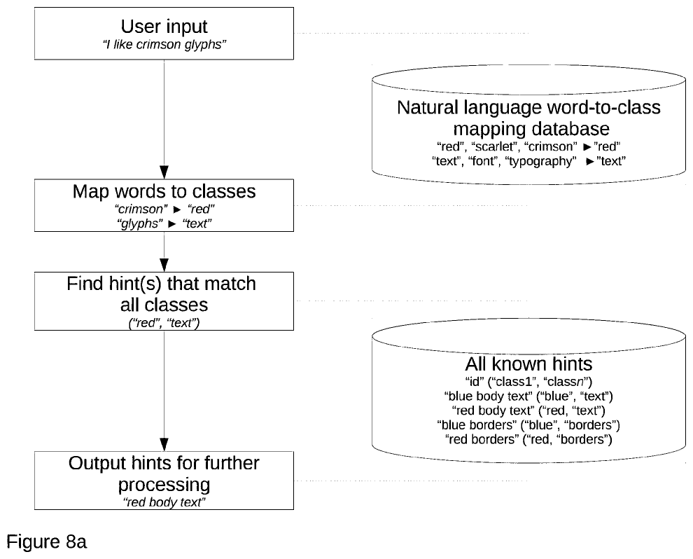

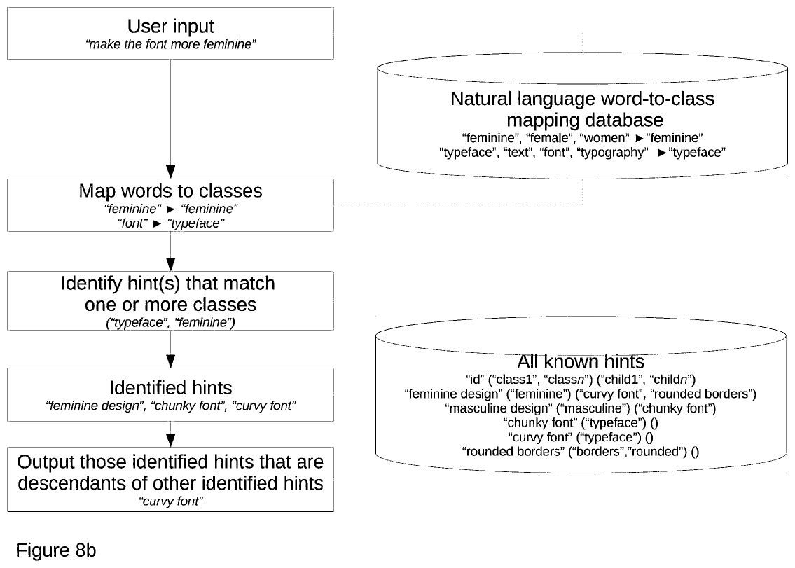

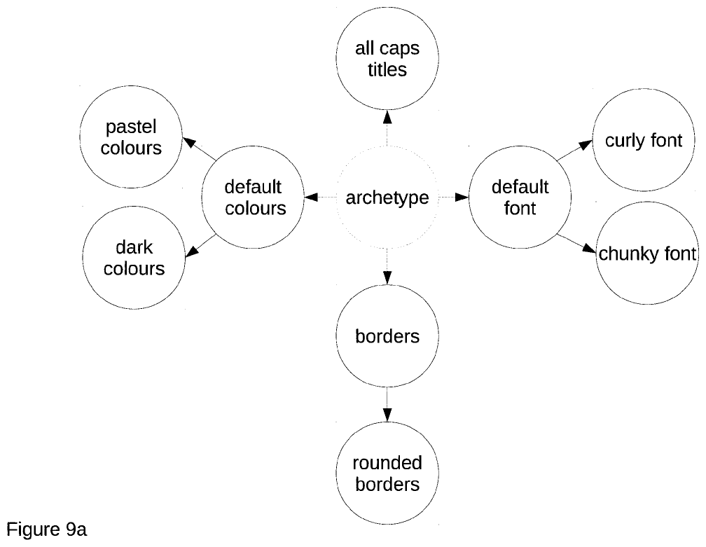

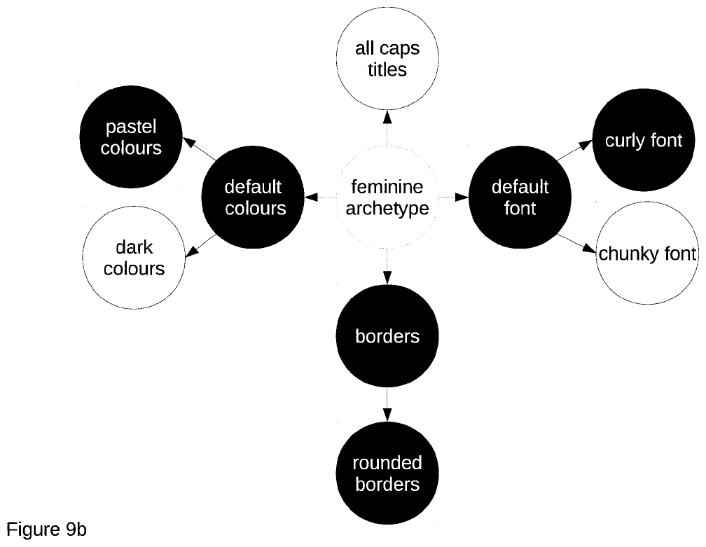

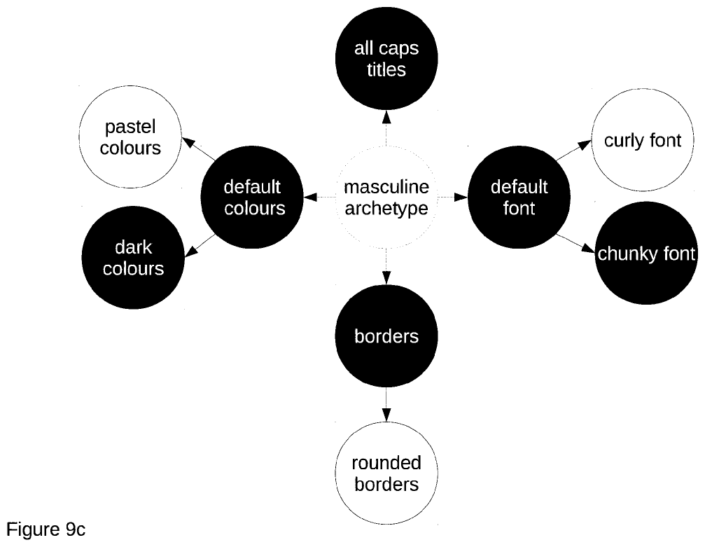

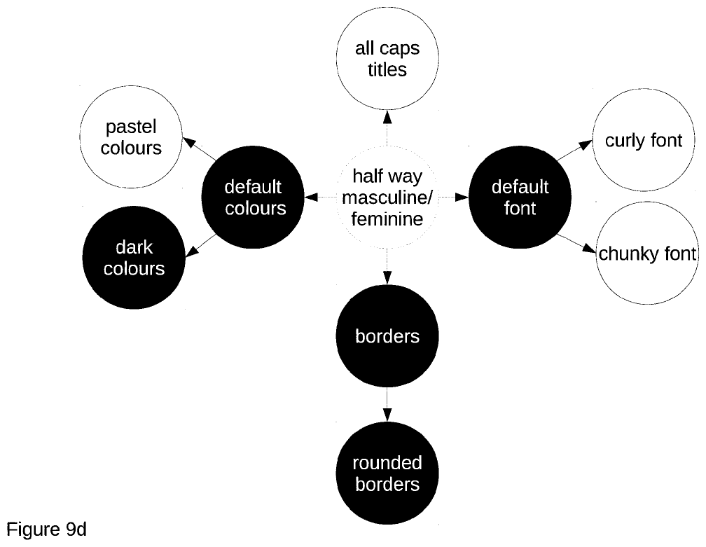

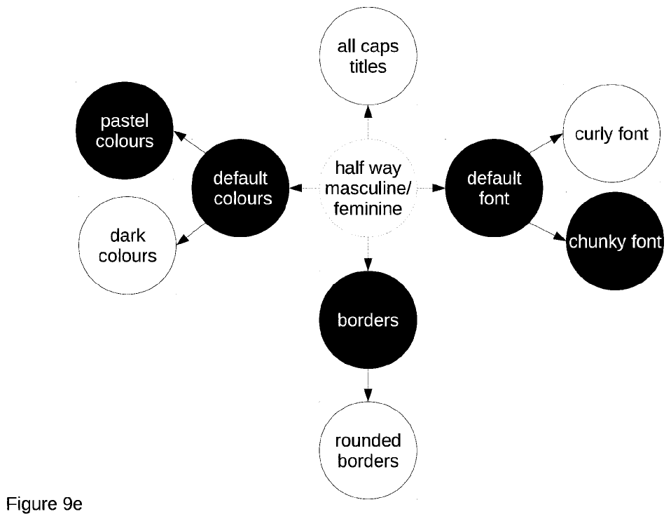

One or more optional hint qualifiers (hereafter referred to as “classes”) are preferably associated with each hint, which encode a “general concept” that this hint pertains to, such as for example “text color”, “border thickness”, “navigation position”, etc. One could even decide to record more abstract notions such as “masculine”, “feminine”, “modern” or “colourful” for high-level macro hints that govern many hints at once, for example if a high-level macro visual effect on the design is reminiscent of such abstract concepts or design direction. As noted hereinbefore, such abstract notions can end up being large collections of hints under one or more “design archetype” hints as depicted in FIGS. 2, 9b and 9c. These “general concepts” help classify hints so that they can be more easily targeted by, for example, programming logic that maps user input (whether in the form of text or otherwise) to hint classes. For example, referring to FIG. 8a, where an example of how user input is mapped to hint classes and then hints is shown. In this example, a computer program tasked with interpreting natural language text input, using known natural language processing algorithms, could map varied natural language imperatives such as “can you make the text color red”, “please make the typography scarlet” and “I like crimson glyphs” to one and the same “text color” and “red” hint classes. Then, by finding the hint(s) that have both “text color” and “red” set as classes, the correct hints can be identified. The found hints can now, for example, be added to the currently selected collection of hints (e.g. the “design” as the user experienced it before issuing the imperative), upon which they are solved by a solver and the new collection of hints is returned. Re-evaluation of the styling instructions associated with the updated hints collection by all platforms, will now ensure that the text is indeed rendered red as requested on platforms that are able to do so.

FIG. 8b is an example of how more conceptually abstract user input is mapped to hint classes and then hints. Using the classes associated with the hints, it is possible to adequately respond to otherwise ambiguous natural language imperatives like “make the font more feminine”. Referring to FIG. 8b, the latter is accomplished as follows. A number of design “archetypes” are encoded, e.g. aforementioned “macro” hints that trigger a lot of different child hints that cause sweeping design changes. Such archetype hints may, for example, constitute a large collection of design changes/elements that express “femininity” in a design. Such an archetype/macro hint has a “class” encoded along with it, for example, “feminine”. The word “feminine” (or “female” or “woman”, etc.) is mapped by natural language processing to the “feminine” qualifier of the macro hint. The word “text” (or “font”, etc.) is also mapped by natural language processing to, say, a “typeface” class, which has been previously encoded along with all hints that cover typography. By filtering all child hints of the “feminine” macro hint for just those child hints that have a “typeface” class associated with them, it is possible to determine what typography hints are considered “feminine”. By now executing the code for just those typography hints it is possible to make just the typography look “feminine”.

From these examples, it will be appreciated by the person skilled in the art that the aforementioned mechanisms lend themselves to all manner of seemingly intelligent responses by variations on the filtering. For example, it may quite readily be possible to come up with a correct response for “I don't like anything, except the font changes” using, again, the combination of natural language processing and mapping natural language to hints (or collections thereof) by looking up their classes. Assuming a previous collection of hints is recorded (for the purpose of this example the “undo” state, e.g. the collection of hints that made up the design before the unwanted design changes were made), it will be possible to filter for just the typography hints of the current (unwanted) design, add them to the ‘undo’ state's collection (with proper resolution) and present that to the user as the “new” design. The “new” design should now reflect what the user asked for, namely, the “previous” design, however with the typography of the “unwanted” design.

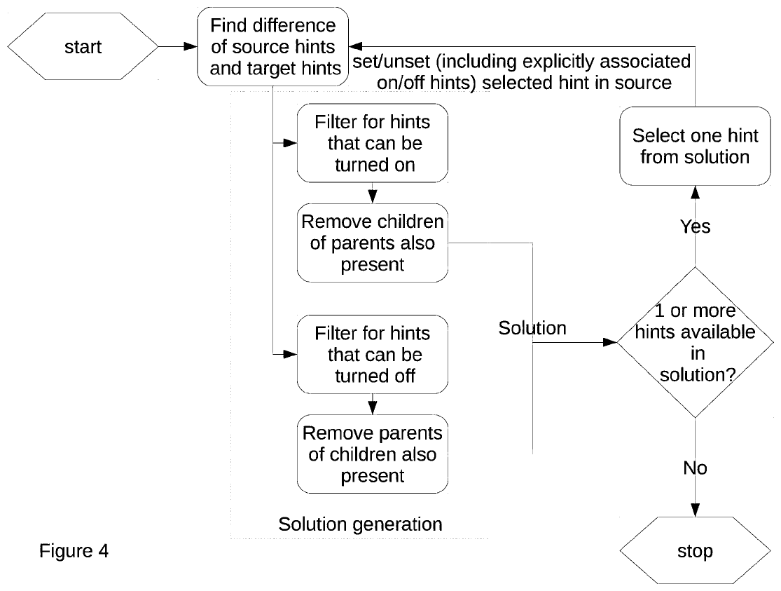

An optional unique, human interpretable description may be provided along with each hint. This may be, for example in the form of a thumbnail/image, a natural language text string, or indices thereto. Specifically, these natural language text strings and/or example images explain in human-relatable terms what design aspect the hint governs or pertains to. Combined with the aforementioned hint classes and user input mapping, this allows for identifying user-desired (or undesired) hint candidates by means of natural language and/or visual examples. Furthermore, by means of a graph solver, there is provision for articulating a solution path, effectively communicating a thought process behind design decisions by means of rendering the human interpretable description for each intermediary step and in addition to an indication of what happened to the hint (turned on or off). FIG. 4 is a flow chart describing an exemplary graph solving algorithm that iteratively finds a path from a first (source) set of hints to a second (target) set of hints. Articulating the thought process is then accomplished by conveying the textual or visual description for each new (or removed) hint, as the solver, as shown by the example of FIG. 4, iterates on the way from the source collection of hints to the target collection of hints.

The preceding described embodiments make it possible to articulate the design decisions and rationale in detail, including rationalising the resolution of clashing design elements. This would allow for the implementation of a user interface that negates some of these decisions if they are deemed undesirable by simply intervening during the solving; by allowing solution hints (and subsequent hints, based on those solution hints in a cascading fashion) to be ignored (or confirmed) upon communication to the user. Accordingly, a design can quickly be shaped by the user.

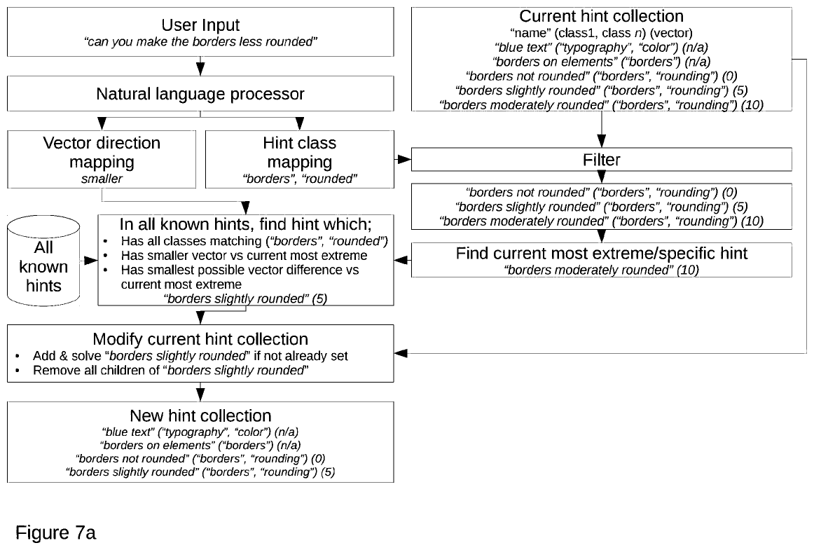

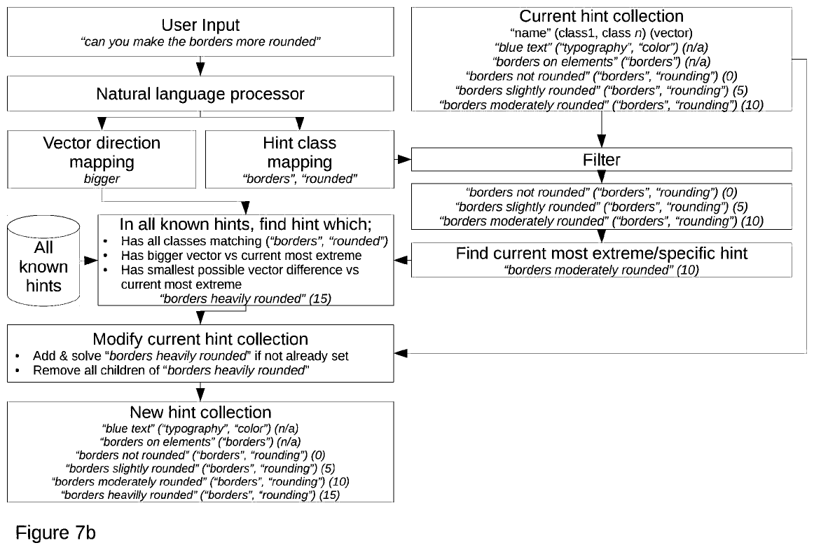

Optionally, a “vector” may be associated with a hint which indicates how “extreme” or “conservative” a hint is in relation to its parent and children hints of the same class. In one example this allows natural language processing algorithms to map natural language quantifiers such as “less”, “more”, “bigger”, “smaller”, “higher”, “lower”, etc. to a graph traversal direction. FIG. 7a is an example of how hint class and vector mapping is used to modify an aspect of a design in a less extreme direction, whereas FIG. 7b is an example of how hint class and vector mapping is used to modify an aspect of a design in a more extreme direction. Considering FIG. 7a, for example, when a user requests “can you make the borders less rounded”, a natural language processing algorithm can map the words “borders” and “rounded” to all hints with the appropriate classes, while it can map “less” to mean a vector reduction. Following that, a search is performed for the most extreme (or “specific”) hint currently set (e.g. currently visible in the design) that matches the “borders” and “rounded” mapping. A measure for “specificity” can be defined by, for example longest distance to a root node, longest distance to the last ancestor that still has the same classes set, or simply testing whether a node is a leaf node in the context of the current collection of hints. After this currently “most extreme/specific” hint has been found, it may then find the descendant or ancestor that also matches the “borders” and “rounded” mapping, however with a smaller (as specified by the “less” natural language mapping) vector value. Then, by looking for the hint with the smallest difference in vector value compared to the currently “most extreme/specific” hint set, it can be ensured that the change/difference in visual appearance is the smallest possible (reflecting the word “less”, as requested). Once this hint has been found, the appropriate changes can then be made to the current collection of hints. That is, making sure that the found hint is turned on and solved, while making sure that all its children are turned off. Re-evaluation of the styling instructions associated with the updated hints collection will now ensure that the borders are indeed rendered less round as requested.

FIG. 7b shows a similar flow of events for the imperative “can you make the border more rounded”, as opposed to less rounded. The flow of events is very similar, with the exception that the implementation searches for a vector value that is bigger, rather than smaller.

Optionally, by modifying the condition “Has smallest possible vector difference vs current most extreme hint” in FIGS. 7a and 7b to “Has largest possible vector difference vs current most extreme hint”, the behaviour changes to finding the most extreme cases that still satisfy the classes and vector direction. In the case of the rounded borders example, this would, for example, satisfy imperatives such as “can you make the font extremely big” or “can you make the font extremely small”.

It will be appreciated by the person skilled in the art that, using this mechanism, intermediate or “in between” vector values can be targeted as well, for example through an imperative such as “can you make the font a lot bigger”. In this case, multiple steps as indicated by “a lot bigger” (rather than just one step) towards the most extreme case may be taken.

It will also be appreciated by the person skilled in the art that, this mechanism could be driven by picking any vector value, in response to an imperative, that sits on a continuum between least extreme vector value and most extreme vector value and finding the hint that matches most closely to this vector value. By doing so, it is possible to respond to imperatives such as “can you make the font medium sized”, assuming “medium sized” maps to a vector value that sits roughly in between the most extreme vector value and least extreme vector value for hints that govern font size. Advantageously, this allows for scaling, either scaling up or scaling done in response to effectively an infinite variety of imperatives.

Additionally, a node distance calculation can be used in the user interface of a computer program that is interacting with the user for finding the anti-thesis of a design concept (such as “modern”) as specified by a collection of hints. Hence, by computing the solution(s) that maximises the distance to, for example, “modern” the anti-thesis of “modern” (e.g. “classic” or “conservative”) may be located.

In a preferred embodiment, a solver could be implemented as follows. The first step to solve the path from one set of hints to another is to thoroughly resolve all hints of the source and, separately, target collection into their constituent on and off hints, for example, as depicted by FIG. 1.

It is therefore possible to solve the path from the source to the target by, for example, an algorithm similar to that exemplified in the flowchart of FIG. 4. By counting how many times the algorithm generates a solution on the way from source hint collection to target hint collection, a measure of distance can be derived. Note that instead of counting solutions, alternatively the proposed “visual impact” scores for each visited node may be added up instead, in order to incorporate such a feature.

The algorithm of FIG. 4 repeatedly compares the source, which gets updated every iteration by means of the algorithm of FIG. 1, to the target and evaluates the difference in hints.

In preferred embodiments, it is possible to separately filter for hints that need to be turned on and off in order to achieve the target.

For the “on” hints, an implemented algorithm will filter out children that have a parent that is also present in the “on” hints, for example, it is not appropriate to offer “blue” as an “on” solution if “text color” has not been set yet in the source hints.

For the “off” hints, an implemented algorithm will filter out parents that have a child that is also present in the “off” hints, for example, it is not appropriate to offer “rounded slightly” as an “off” solution if “rounded heavily” is still set in the source hints.

The aggregate of filtered “on” and “off” solutions, which are valid choices that represent one step closer to the target hint collection, is then presented to a selection algorithm. This selection algorithm then selects one solution from the solutions set (for example randomly) upon which the turning on or off of the picked solution hint is enacted using an algorithm similar to that of FIG. 1. It is to be noted that again this may result in the addition or removal of more hints, depending on the explicit hint collection associated with the solution hint. The process is then repeated.

If no further solution can be found, the solver is finished.

FIG. 9b is an example of a “feminine” archetype using hints from the full knowledge graph of FIG. 9a, where the coloured-in nodes represent hints that are set. FIG. 9c is an example of a “masculine” archetype using hints from the full knowledge graph of FIG. 9a, where the coloured-in nodes represent hints that are set. FIG. 9d is an example of a valid half-way solution between the “feminine” archetype of FIG. 9b and the “masculine” archetype of FIG. 9b, where the coloured-in nodes represent hints that are set. FIG. 9e is a second example of a valid half-way solution between the “feminine” archetype of FIG. 9b and the “masculine” archetype of FIG. 9b, where the coloured-in nodes represent hints that are set.

By means of a solving algorithm, for example as shown in FIG. 4, it is possible to solve between, for example, two design archetypes (see FIGS. 9b and 9c) that encode a valid sub-selection of hints from the full hint knowledge graph, an example of which is illustrated in FIG. 9a, whereby one can successfully achieve “halfway points” such as depicted in FIG. 9d. Such a “halfway point” would be the point where half of all solutions have been successfully calculated and applied to the source collection of hints. At this point, the design would be in a state that incorporates both design elements (hints) from both the source and the target collection of hints.

Given that there are typically many solutions that satisfy this condition due to the branching nature of the graph, the number of possible combinations that are visually reminiscent of a 50/50 blend of such archetypes is typically much greater than 1. The resultant halfway point selections of FIG. 9e is, just like that of FIG. 9d, an equally valid half way point between the archetypes depicted in FIGS. 9b and 9c. In both cases of FIG. 9d and FIG. 9e, three solutions have been calculated and applied, and three more are needed to reach the other archetype of either FIG. 9b or FIG. 9c.

It will be appreciated by the reader that introducing more than two archetypes this way greatly increases the amount of solutions that are an optimal blend. It also to be appreciated that it is possible to choose any point in between the source collection of hints and the target collection of hints, rather than just picking the optimal half way point. Accordingly, it would be appreciated that the introduction of just a few archetypes with associated moderately complex, branching, cascading hints, yields a vast amount of different possible designs. In fact, it is considered that the number of possible designs that can be provided by the embodiments of the present invention would far exceed the amount of designs that could be produced by a user of prior art systems in multiple lifetimes.

The optional “visual impact” score (effectively a weighting factor) on a predetermined scale could be associated with each hint to further enhance path solver solution comparisons, and help to better articulate design decisions and guidance advice to an end user. In essence, such a weighting factor recognises that not all design decisions are equal. One hint, for example a hint that changes the background colour to red, could be deemed to have more of an impact than another, for example a hint that changes border thickness from 9 to 10 pixels. Without a weighting factor, aforementioned design changes would both be counted as one “step” (e.g. a single solution application iteration from the solver) and therefore one unit of distance “away” or “closer” to another design. However with the weighting factor, visual impact can be properly weighted in terms of “closeness” to other designs.

Employing a graph solver to calculate the distance (with or without the visual impact enhancement) between two collections of hints, further allows for a system to make estimates of how similar or dissimilar the collections are to one another. These estimates can then be conveyed to the user interface of a computer program that is interacting with the user to inform them of this information. By determining which archetypes have the shortest distance to the current design, a user interface can, for example, give an abstract qualification of the current design such as “this design is mostly feminine, with slightly modern and elegant qualities”. This message would be provided owing to, for example a very low distance to a “feminine” archetype and reasonably close distances to a “modern” and an “elegant” archetype, but otherwise very high distance values to other archetypes.

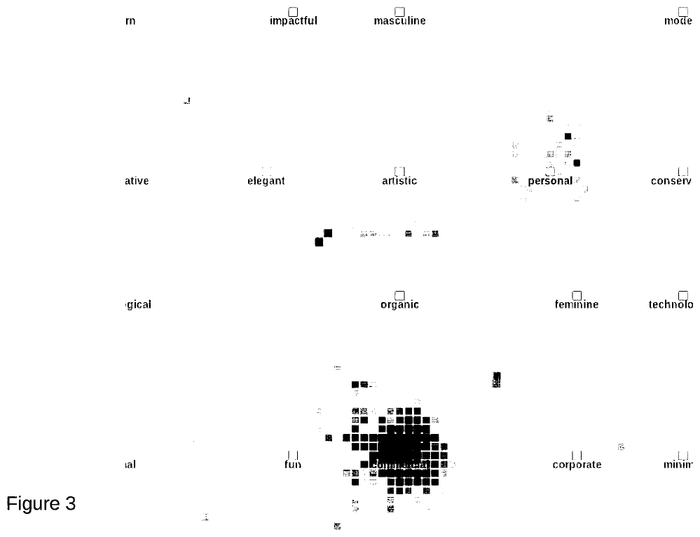

Furthermore, by evenly spreading a number of archetypes over a 2D grid and marking their location, while filling the grid nodes between the archetypes with interpolated hint collections based on the distance from each archetype, it is then possible to match any given hint collection against each square of the 2D grid and calculate a matching score for that square. By assigning RGB or brightness values to elements of the grid matrix according to closeness of the score to each square of the grid, a map can be synthesised that visually shows which archetypes are close to the current design and which are not. This is analogous to a brain activity map, for example a rendering like that of FIG. 3. FIG. 3 is an n-matrix output of a Self Organizing Map (Kohonen network) Artificial Neural Net that has been trained with archetypal hint collections and valid in-between solutions. Overlaid is a closeness-of-fit gray scale for every solution in the matrix, yielding an image analogous to a functional magnetic resonance imaging (fMRI) scan, mapping brain activity of a biological brain. This assignment of values to grid result is somewhat similar to the output of a Self Organising Map (Kohonen Network) Artificial Neural Net and can further be used in a similar manner to pick designs based on their topology in relation the pure archetype locations on such a map. By way of example, this can be achieved by choosing a grid location in between archetypes and consulting the hint collection that was used to generate the RGB or brightness value for that grid location. Alternatively, a true Self Organising Map Artificial Neural Net may be trained using randomised (but valid) designs, which would also be accomplishing something analogous to a brain activity map that can be used in the aforementioned manner. It would be appreciated by the reader that it is possible to have multiple brain maps in this way that show different types of archetypes that control different aspects of a design. For example, one could have design archetypes, layout archetypes, colour archetypes, etc.

While this invention has been described in connection with specific embodiments thereof, it will be understood that it is capable of further modification(s). This application is intended to cover any variations uses or adaptations of the invention following in general, the principles of the invention and including such departures from the present disclosure as come within known or customary practice within the art to which the invention pertains and as may be applied to the essential features hereinbefore set forth.

As the present invention may be embodied in several forms without departing from the spirit of the essential characteristics of the invention, it should be understood that the above described embodiments are not to limit the present invention unless otherwise specified, but rather should be construed broadly within the spirit and scope of the invention as defined in the appended claims. The described embodiments are to be considered in all respects as illustrative only and not restrictive.

Various modifications and equivalent arrangements are intended to be included within the spirit and scope of the invention and appended claims. Therefore, the specific embodiments are to be understood to be illustrative of the many ways in which the principles of the present invention may be practiced. In the following claims, any means-plus-function clauses are intended to cover structures as performing the defined function and not only structural equivalents, but also equivalent structures. For example, although a nail and a screw may not be structural equivalents in that a nail employs a cylindrical surface to secure wooden parts together, whereas a screw employs a helical surface to secure wooden parts together, in the environment of fastening wooden parts, a nail and a screw are equivalent structures.

The following sections I-VII provide a guide to interpreting the present specification.

### I. Terms

The term “product” means any machine, manufacture and/or composition of matter, unless expressly specified otherwise.

The term “process” means any process, algorithm, method or the like, unless expressly specified otherwise.

Each process (whether called a method, algorithm or otherwise) inherently includes one or more steps, and therefore all references to a “step” or “steps” of a process have an inherent antecedent basis in the mere recitation of the term ‘process’ or a like term. Accordingly, any reference in a claim to a ‘step’ or ‘steps’ of a process has sufficient antecedent basis.

The term “invention” and the like mean “the one or more inventions disclosed in this specification”, unless expressly specified otherwise.

The terms “an embodiment”, “embodiment”, “embodiments”, “the embodiment”, “the embodiments”, “one or more embodiments”, “some embodiments”, “certain embodiments”, “one embodiment”, “another embodiment” and the like mean “one or more (but not all) embodiments of the disclosed invention(s)”, unless expressly specified otherwise.

The term “variation” of an invention means an embodiment of the invention, unless expressly specified otherwise.

A reference to “another embodiment” in describing an embodiment does not imply that the referenced embodiment is mutually exclusive with another embodiment (e.g., an embodiment described before the referenced embodiment), unless expressly specified otherwise.

The terms “including”, “comprising” and variations thereof mean “including but not limited to”, unless expressly specified otherwise.

The terms “a”, “an” and “the” mean “one or more”, unless expressly specified otherwise.

The term “plurality” means “two or more”, unless expressly specified otherwise.

The term “herein” means “in the present specification, including anything which may be incorporated by reference”, unless expressly specified otherwise.

The phrase “at least one of”, when such phrase modifies a plurality of things (such as an enumerated list of things), means any combination of one or more of those things, unless expressly specified otherwise. For example, the phrase “at least one of a widget, a car and a wheel” means either (i) a widget, (ii) a car, (iii) a wheel, (iv) a widget and a car, (v) a widget and a wheel, (vi) a car and a wheel, or (vii) a widget, a car and a wheel. The phrase “at least one of”, when such phrase modifies a plurality of things, does not mean “one of each of” the plurality of things.

Numerical terms such as “one”, “two”, etc. when used as cardinal numbers to indicate quantity of something (e.g., one widget, two widgets), mean the quantity indicated by that numerical term, but do not mean at least the quantity indicated by that numerical term. For example, the phrase “one widget” does not mean “at least one widget”, and therefore the phrase “one widget” does not cover, e.g., two widgets.

The phrase “based on” does not mean “based only on”, unless expressly specified otherwise. In other words, the phrase “based on” describes both “based only on” and “based at least on”. The phrase “based at least on” is equivalent to the phrase “based at least in part on”.

The term “represent” and like terms are not exclusive, unless expressly specified otherwise. For example, the term “represents” do not mean “represents only”, unless expressly specified otherwise. In other words, the phrase “the data represents a credit card number” describes both “the data represents only a credit card number” and “the data represents a credit card number and the data also represents something else”.

The term “whereby” is used herein only to precede a clause or other set of words that express only the intended result, objective or consequence of something that is previously and explicitly recited. Thus, when the term “whereby” is used in a claim, the clause or other words that the term “whereby” modifies do not establish specific further limitations of the claim or otherwise restricts the meaning or scope of the claim.

The term “e.g.” and like terms mean “for example”, and thus does not limit the term or phrase it explains. For example, in the sentence “the computer sends data (e.g., instructions, a data structure) over the Internet”, the term “e.g.” explains that “instructions” are an example of “data” that the computer may send over the Internet, and also explains that “a data structure” is an example of “data” that the computer may send over the Internet. However, both “instructions” and “a data structure” are merely examples of “data”, and other things besides “instructions” and “a data structure” can be “data”.

The term “i.e.” and like terms mean “that is”, and thus limits the term or phrase it explains. For example, in the sentence “the computer sends data (i.e., instructions) over the Internet”, the term “i.e.” explains that “instructions” are the “data” that the computer sends over the Internet.

Any given numerical range shall include whole and fractions of numbers within the range. For example, the range “1 to 10” shall be interpreted to specifically include whole numbers between 1 and 10 (e.g., 2, 3, 4, . . . 9) and non-whole numbers (e.g., 1.1, 1.2, . . . 1.9).

### II. Determining

The term “determining” and grammatical variants thereof (e.g., to determine a price, determining a value, determine an object which meets a certain criterion) is used in an extremely broad sense. The term “determining” encompasses a wide variety of actions and therefore “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing, and the like.

The term “determining” does not imply certainty or absolute precision, and therefore “determining” can include estimating, extrapolating, predicting, guessing and the like.

The term “determining” does not imply that mathematical processing must be performed, and does not imply that numerical methods must be used, and does not imply that an algorithm or process is used.

The term “determining” does not imply that any particular device must be used. For example, a computer need not necessarily perform the determining.

### III. Indication

The term “indication” is used in an extremely broad sense. The term “indication” may, among other things, encompass a sign, symptom, or token of something else.

The term “indication” may be used to refer to any indicia and/or other information indicative of or associated with a subject, item, entity, and/or other object and/or idea.

As used herein, the phrases “information indicative of” and “indicia” may be used to refer to any information that represents, describes, and/or is otherwise associated with a related entity, subject, or object.

Indicia of information may include, for example, a symbol, a code, a reference, a link, a signal, an identifier, and/or any combination thereof and/or any other informative representation associated with the information.

In some embodiments, indicia of information (or indicative of the information) may be or include the information itself and/or any portion or component of the information. In some embodiments, an indication may include a request, a solicitation, a broadcast, and/or any other form of information gathering and/or dissemination.

### IV. Forms of Sentences

Where a limitation of a first claim would cover one of a feature as well as more than one of a feature (e.g., a limitation such as “at least one widget” covers one widget as well as more than one widget), and where in a second claim that depends on the first claim, the second claim uses a definite article “the” to refer to the limitation (e.g., “the widget”), this does not imply that the first claim covers only one of the feature, and this does not imply that the second claim covers only one of the feature (e.g., “the widget” can cover both one widget and more than one widget).

When an ordinal number (such as “first”, “second”, “third” and so on) is used as an adjective before a term, that ordinal number is used (unless expressly specified otherwise) merely to indicate a particular feature, such as to distinguish that particular feature from another feature that is described by the same term or by a similar term. For example, a “first widget” may be so named merely to distinguish it from, e.g., a “second widget”. Thus, the mere usage of the ordinal numbers “first” and “second” before the term “widget” does not indicate any other relationship between the two widgets, and likewise does not indicate any other characteristics of either or both widgets. For example, the mere usage of the ordinal numbers “first” and “second” before the term “widget” (1) does not indicate that either widget comes before or after any other in order or location; (2) does not indicate that either widget occurs or acts before or after any other in time; and (3) does not indicate that either widget ranks above or below any other, as in importance or quality. In addition, the mere usage of ordinal numbers does not define a numerical limit to the features identified with the ordinal numbers. For example, the mere usage of the ordinal numbers “first” and “second” before the term “widget” does not indicate that there must be no more than two widgets.

When a single device or article is described herein, more than one device/article (whether or not they cooperate) may alternatively be used in place of the single device/article that is described. Accordingly, the functionality that is described as being possessed by a device may alternatively be possessed by more than one device/article (whether or not they cooperate).

Similarly, where more than one device or article is described herein (whether or not they cooperate), a single device/article may alternatively be used in place of the more than one device or article that is described. For example, a plurality of computer-based devices may be substituted with a single computer-based device. Accordingly, the various functionality that is described as being possessed by more than one device or article may alternatively be possessed by a single device/article.

The functionality and/or the features of a single device that is described may be alternatively embodied by one or more other devices which are described but are not explicitly described as having such functionality/features. Thus, other embodiments need not include the described device itself, but rather can include the one or more other devices which would, in those other embodiments, have such functionality/features.

### V. Disclosed Examples and Terminology are not Limiting

Neither the Title nor the Abstract in this specification is intended to be taken as limiting in any way as the scope of the disclosed invention(s). The title and headings of sections provided in the specification are for convenience only, and are not to be taken as limiting the disclosure in any way.

Numerous embodiments are described in the present application, and are presented for illustrative purposes only. The described embodiments are not, and are not intended to be, limiting in any sense. The presently disclosed invention(s) are widely applicable to numerous embodiments, as is readily apparent from the disclosure. One of ordinary skill in the art will recognise that the disclosed invention(s) may be practised with various modifications and alterations, such as structural, logical, software, and electrical modifications. Although particular features of the disclosed invention(s) may be described with reference to one or more particular embodiments and/or drawings, it should be understood that such features are not limited to usage in the one or more particular embodiments or drawings with reference to which they are described, unless expressly specified otherwise.

The present disclosure is not a literal description of all embodiments of the invention(s). Also, the present disclosure is not a listing of features of the invention(s) which must be present in all embodiments.

Devices that are described as in communication with each other need not be in continuous communication with each other, unless expressly specified otherwise. On the contrary, such devices need only transmit to each other as necessary or desirable, and may actually refrain from exchanging data most of the time. For example, a machine in communication with another machine via the Internet may not transmit data to the other machine for long period of time (e.g. weeks at a time). In addition, devices that are in communication with each other may communicate directly or indirectly through one or more intermediaries.

A description of an embodiment with several components or features does not imply that all or even any of such components/features are required. On the contrary, a variety of optional components are described to illustrate the wide variety of possible embodiments of the present invention(s). Unless otherwise specified explicitly, no component/feature is essential or required.

Although process steps, operations, algorithms or the like may be described in a particular sequential order, such processes may be configured to work in different orders. In other words, any sequence or order of steps that may be explicitly described does not necessarily indicate a requirement that the steps be performed in that order. The steps of processes described herein may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to the invention(s), and does not imply that the illustrated process is preferred.

Although a process may be described as including a plurality of steps, that does not imply that all or any of the steps are preferred, essential or required. Various other embodiments within the scope of the described invention(s) include other processes that omit some or all of the described steps. Unless otherwise specified explicitly, no step is essential or required.

Although a process may be described singly or without reference to other products or methods, in an embodiment the process may interact with other products or methods. For example, such interaction may include linking one business model to another business model. Such interaction may be provided to enhance the flexibility or desirability of the process.

Although a product may be described as including a plurality of components, aspects, qualities, characteristics and/or features, that does not indicate that any or all of the plurality are preferred, essential or required. Various other embodiments within the scope of the described invention(s) include other products that omit some or all of the described plurality.

An enumerated list of items (which may or may not be numbered) does not imply that any or all of the items are mutually exclusive, unless expressly specified otherwise. Likewise, an enumerated list of items (which may or may not be numbered) does not imply that any or all of the items are comprehensive of any category, unless expressly specified otherwise. For example, the enumerated list “a computer, a laptop, a PDA” does not imply that any or all of the three items of that list are mutually exclusive and does not imply that any or all of the three items of that list are comprehensive of any category.

An enumerated list of items (which may or may not be numbered) does not imply that any or all of the items are equivalent to each other or readily substituted for each other.

All embodiments are illustrative, and do not imply that the invention or any embodiments were made or performed, as the case may be.

### VI. Computing

It will be readily apparent to one of ordinary skill in the art that the various processes described herein may be implemented by, e.g., appropriately programmed general purpose computers, special purpose computers and computing devices. Typically a processor (e.g., one or more microprocessors, one or more micro-controllers, one or more digital signal processors) will receive instructions (e.g., from a memory or like device), and execute those instructions, thereby performing one or more processes defined by those instructions.

A “processor” means one or more microprocessors, central processing units (CPUs), computing devices, micro-controllers, digital signal processors, or like devices or any combination thereof.

Thus a description of a process is likewise a description of an apparatus for performing the process. The apparatus that performs the process can include, e.g., a processor and those input devices and output devices that are appropriate to perform the process.

Further, programs that implement such methods (as well as other types of data) may be stored and transmitted using a variety of media (e.g., computer readable media) in a number of manners. In some embodiments, hard-wired circuitry or custom hardware may be used in place of, or in combination with, some or all of the software instructions that can implement the processes of various embodiments. Thus, various combinations of hardware and software may be used instead of software only.

The term “computer-readable medium” refers to any medium, a plurality of the same, or a combination of different media, that participate in providing data (e.g., instructions, data structures) which may be read by a computer, a processor or a like device. Such a medium may take many forms, including but not limited to, non-volatile media, volatile media, and transmission media. Non-volatile media include, for example, optical or magnetic disks and other persistent memory. Volatile media include dynamic random access memory (DRAM), which typically constitutes the main memory. Transmission media include coaxial cables, copper wire and fibre optics, including the wires that comprise a system bus coupled to the processor. Transmission media may include or convey acoustic waves, light waves and electromagnetic emissions, such as those generated during radio frequency (RF) and infra-red (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave as described hereinafter, or any other medium from which a computer can read.

Various forms of computer readable media may be involved in carrying data (e.g. sequences of instructions) to a processor. For example, data may be (i) delivered from RAM to a processor; (ii) carried over a wireless transmission medium; (iii) formatted and/or transmitted according to numerous formats, standards or protocols, such as Ethernet (or IEEE 802.3), SAP, ATP, Bluetooth™, and TCP/IP, TDMA, COMA, and 3G; and/or (iv) encrypted to ensure privacy or prevent fraud in any of a variety of ways well known in the art.

Thus a description of a process is likewise a description of a computer-readable medium storing a program for performing the process. The computer-readable medium can store (in any appropriate format) those program elements which are appropriate to perform the method.

Just as the description of various steps in a process does not indicate that all the described steps are required, embodiments of an apparatus include a computer/computing device operable to perform some (but not necessarily all) of the described process.

Likewise, just as the description of various steps in a process does not indicate that all the described steps are required, embodiments of a computer-readable medium storing a program or data structure include a computer-readable medium storing a program that, when executed, can cause a processor to perform some (but not necessarily all) of the described process.

Where databases are described, it will be understood by one of ordinary skill in the art that (i) alternative database structures to those described may be readily employed, and (ii) other memory structures besides databases may be readily employed. Any illustrations or descriptions of any sample databases presented herein are illustrative arrangements for stored representations of information. Any number of other arrangements may be employed besides those suggested by, e.g., tables illustrated in drawings or elsewhere. Similarly, any illustrated entries of the databases represent exemplary information only; one of ordinary skill in the art will understand that the number and content of the entries can be different from those described herein. Further, despite any depiction of the databases as tables, other formats (including relational databases, object-based models and/or distributed databases) could be used to store and manipulate the data types described herein. Likewise, object methods or behaviours of a database can be used to implement various processes, such as the described herein. In addition, the databases may, in a known manner, be stored locally or remotely from a device which accesses data in such a database.

Various embodiments can be configured to work in a network environment including a computer that is in communication (e.g., via a communications network) with one or more devices. The computer may communicate with the devices directly or indirectly, via any wired or wireless medium (e.g. the Internet, LAN, WAN or Ethernet, Token Ring, a telephone line, a cable line, a radio channel, an optical communications line, commercial on-line service providers, bulletin board systems, a satellite communications link, a combination of any of the above). Each of the devices may themselves comprise computers or other computing devices that are adapted to communicate with the computer. Any number and type of devices may be in communication with the computer.

In an embodiment, a server computer or centralised authority may not be necessary or desirable. For example, the present invention may, in an embodiment, be practised on one or more devices without a central authority. In such an embodiment, any functions described herein as performed by the server computer or data described as stored on the server computer may instead be performed by or stored on one or more such devices.

Where a process is described, in an embodiment the process may operate without any user intervention. In another embodiment, the process includes some human intervention (e.g., a step is performed by or with the assistance of a human).

It should be noted that where the terms “server”, “secure server” or similar terms are used herein, a communication device is described that may be used in a communication system, unless the context otherwise requires, and should not be construed to limit the present invention to any particular communication device type. Thus, a communication device may include, without limitation, a bridge, router, bridge-router (router), switch, node, or other communication device, which may or may not be secure.

It should also be noted that where a flowchart is used herein to demonstrate various aspects of the invention, it should not be construed to limit the present invention to any particular logic flow or logic implementation. The described logic may be partitioned into different logic blocks (e.g., programs, modules, functions, or subroutines) without changing the overall results or otherwise departing from the true scope of the invention. Often, logic elements may be added, modified, omitted, performed in a different order, or implemented using different logic constructs (e.g., logic gates, looping primitives, conditional logic, and other logic constructs) without changing the overall results or otherwise departing from the true scope of the invention.

Various embodiments of the invention may be embodied in many different forms, including computer program logic for use with a processor (e.g., a microprocessor, microcontroller, digital signal processor, or general purpose computer and for that matter, any commercial processor may be used to implement the embodiments of the invention either as a single processor, serial or parallel set of processors in the system and, as such, examples of commercial processors include, but are not limited to Merced™, Pentium™, Pentium II™ Xeon™, Celeron™, Pentium Pro™, Efficeon™, Athlon™, AMD™ and the like), programmable logic for use with a programmable logic device (e.g., a Field Programmable Gate Array (FPGA) or other PLD), discrete components, integrated circuitry (e.g., an Application Specific Integrated Circuit (ASIC)), or any other means including any combination thereof. In an exemplary embodiment of the present invention, predominantly all of the communication between users and the server is implemented as a set of computer program instructions that is converted into a computer executable form, stored as such in a computer readable medium, and executed by a microprocessor under the control of an operating system.

Computer program logic implementing all or part of the functionality where described herein may be embodied in various forms, including a source code form, a computer executable form, and various intermediate forms (e.g., forms generated by an assembler, compiler, linker, or locator). Source code may include a series of computer program instructions implemented in any of various programming languages (e.g., an object code, an assembly language, or a high-level language such as Fortran, C, C++, JAVA, or HTML. Moreover, there are hundreds of available computer languages that may be used to implement embodiments of the invention, among the more common being Ada; Algol; APL; awk; Basic; C; C++; Conol; Delphi; Eiffel; Euphoria; Forth; Fortran; HTML; Icon; Java; Javascript; Lisp; Logo; Mathematica; MatLab; Miranda; Modula-2; Oberon; Pascal; Perl; PL/I; Prolog; Python; Rexx; SAS; Scheme; sed; Simula; Smalltalk; Snobol; SQL; Visual Basic; Visual C++; Linux and XML.) for use with various operating systems or operating environments. The source code may define and use various data structures and communication messages. The source code may be in a computer executable form (e.g., via an interpreter), or the source code may be converted (e.g., via a translator, assembler, or compiler) into a computer executable form.

The computer program may be fixed in any form (e.g., source code form, computer executable form, or an intermediate form) either permanently or transitorily in a tangible storage medium, such as a semiconductor memory device (e.g, a RAM, ROM, PROM, EEPROM, or Flash-Programmable RAM), a magnetic memory device (e.g., a diskette or fixed disk), an optical memory device (e.g., a CD-ROM or DVD-ROM), a PC card (e.g., PCMCIA card), or other memory device. The computer program may be fixed in any form in a signal that is transmittable to a computer using any of various communication technologies, including, but in no way limited to, analog technologies, digital technologies, optical technologies, wireless technologies (e.g., Bluetooth), networking technologies, and inter-networking technologies. The computer program may be distributed in any form as a removable storage medium with accompanying printed or electronic documentation (e.g., shrink wrapped software), preloaded with a computer system (e.g., on system ROM or fixed disk), or distributed from a server or electronic bulletin board over the communication system (e.g., the Internet or World Wide Web).

Hardware logic (including programmable logic for use with a programmable logic device) implementing all or part of the functionality where described herein may be designed using traditional manual methods, or may be designed, captured, simulated, or documented electronically using various tools, such as Computer Aided Design (CAD), a hardware description language (e.g., VHDL or AHDL), or a PLD programming language (e.g., PALASM, ABEL, or CUPL). Hardware logic may also be incorporated into display screens for implementing embodiments of the invention and which may be segmented display screens, analogue display screens, digital display screens, CRTs, LED screens, Plasma screens, liquid crystal diode screen, and the like.

Programmable logic may be fixed either permanently or transitorily in a tangible storage medium, such as a semiconductor memory device (e.g., a RAM, ROM, PROM, EEPROM, or Flash-Programmable RAM), a magnetic memory device (e.g., a diskette or fixed disk), an optical memory device (e.g., a CD-ROM or DVD-ROM), or other memory device. The programmable logic may be fixed in a signal that is transmittable to a computer using any of various communication technologies, including, but in no way limited to, analog technologies, digital technologies, optical technologies, wireless technologies (e.g., Bluetooth), networking technologies, and internetworking technologies. The programmable logic may be distributed as a removable storage medium with accompanying printed or electronic documentation (e.g., shrink wrapped software), preloaded with a computer system (e.g., on system ROM or fixed disk), or distributed from a server or electronic bulletin board over the communication system (e.g., the Internet or World Wide Web).

“Comprises/comprising” and “includes/including” when used in this specification is taken to specify the presence of stated features, integers, steps or components but does not preclude the presence or addition of one or more other features, integers, steps, components or groups thereof. Thus, unless the context clearly requires otherwise, throughout the description and the claims, the words ‘comprise’, ‘comprising’, ‘includes’, ‘including’ and the like are to be construed in an inclusive sense as opposed to an exclusive or exhaustive sense; that is to say, in the sense of “including, but not limited to”.

1. A method of producing a user-preferred digital media content design by automatically configuring one or a combination of hints for representing content which is non-specific to a terminating platform, the method comprising the steps of:
mapping components of at least one imperative derived from user input to respective hint classes;
matching all hints from a set of known hints with the hint classes that have been mapped with the components of the at least one imperative derived from user input.

2. A method as claimed in claim 1 wherein the steps of mapping and matching are repeated.

3. A method as claimed in claim 1 further comprising the step of combining the matched hints with an existing collection of hints.

4. A method as claimed in claim 1 wherein the hints comprise a composite of parent and/or child hints.

5. A method as claimed in claim 4 wherein the composite of parent and/or child hints is derived from an archetypal graph.

6. A method as claimed in claim 1 wherein the at least one imperative is derived from user input by use of natural language processing.

7. A method as claimed in claim 1 wherein the components of derived imperatives comprise a range of progressively conceptually abstract user input.

8. A method as claimed in claim 1 wherein the step of mapping further includes mapping a vector associated with a hint as a measure of specificity and wherein the method further comprises the step of searching for hints based on predetermined specificity criteria.

9. A method as claimed in claim 3 wherein the step of combining further includes effecting changes to one or more hints within the existing collection of hints or the combined hints.

10. A method as claimed in claim 9 wherein the effected changes include turning a hint on or off.

11. A method as claimed in claim 5 further comprising the step of solving the archetypal graph to determine a path from a first source set of hints to a second target set of hints.

12. A method as claimed in claim 11 wherein the step of solving further includes determining one or a combination of points on the path between the first source set of hints and the second target set of hints.

13. A method as claimed in claim 12 further including the step of associating a visual impact score with at least one hint by application of a weighting factor.

14. A method as claimed in claim 11 further including the step of calculating the distance between two collections of hints.

15. (canceled)

16. An article representing content, characterised by being the product of the method as claimed in claim 1.

17. An article as claimed in claim 16 wherein the article comprises one or a combination of:
a printable document;
a visual display;
an audio-visual display;
an audio playback file;
a multi-media file;
a multi-media display.

18. A computer program product comprising:
a computer usable medium having computer readable program code and computer readable system code embodied on said medium for producing a user-preferred digital media content design by automatically configuring one or a combination of hints for representing content which is non-specific to a terminating platform within a data processing system, said computer program product comprising:
computer readable code within said computer usable medium for performing the steps of claim 1.

19. A terminating platform, service or media residing in a digital media system adapted to interpret hints and produce a user-preferred digital media content design according to a method as claimed in claim 1.

20. (canceled)

21. (canceled)
